(19) United States
(12) Patent Application Publication
(10) Pub. No.: US 2019/0234472 A1
(43) Pub. Date: Aug. 1, 2019

(54) RETRACTION SPRING

(71) Applicant: Akebono Brake Industry Co., Ltd., Tokyo (JP)

(72) Inventor: Kirby Lee Wilson, Lathrup Village, MI (US)

(21) Appl. No.: 15/881,106

(22) Filed: Jan. 26, 2018

(51) Int. Cl. F16D 65/097; F16D 65/22

(52) U.S. Cl. CPC F16D 65/0975; F16D 2121/16; F16D 65/22

(57) ABSTRACT

A retraction spring comprising: (a) a body portion; (b) a first end; and (c) a second end, the second end connected to the first end via the body portion, wherein the retraction spring is configured to connect between mounting points of a caliper housing and attachment points along a bottom peripheral edge of one or more brake pad assemblies.

### FIELD

The present teachings generally relate to a brake system, and more particularly, to a retraction spring that assists in retracting brake pad assemblies.

### BACKGROUND OF THE INVENTION

A brake system may frequently be used to decelerate a vehicle, such as an automobile, motorcycle, or airplane. The brake system may perform a brake apply to the vehicle by moving one or more brake pads into contact with a rotating brake rotor to create a clamping force. The clamping force in turn functions to decelerate the vehicle.

The brake pads may move substantially axially along the axis of rotation of the brake rotor to apply and release the clamping force. Frequently, the brake pads may be guided along one or more abutment features, such as a pin or a support bracket, to help maintain the substantially axial movement. The friction material of the brake pads may be affixed to one or more pressure plates that include a through-hole to receive and follow one or more surfaces of the abutment feature (e.g., the pin) or an ear that extends into a channel in the support bracket, the caliper body, or both. As the brake pads are moved between clamping and releasing, an increase in frictional force between the friction materials and/or pressure plates and the one or more abutment features may occur. This frictional force may cause the brake pads to move, tilt, rotate, pivot, have a non-planar movement, or a combination thereof relative to the brake rotor. Additionally, when the brake pads are moved into contact with a rotating brake rotor, torque is applied by the brake rotor onto the brake pads, which may also cause the brake pads to move, tilt, rotate, pivot, or a combination thereof relative to the brake rotor. The movement, tilting, rotation, pivoting, or a combination thereof of the brake pads may result in uneven wear of the brake pads, uneven wear of the rotor, brake pad distortion, reduced life of the brake pads or rotor, failure of the brake system, or a combination thereof.

To aid in retraction of the brake pads relative to the brake rotor, the brake system may also include one or more clips and/or one or more springs. However, the addition of these one or more clips and/or one or more springs may be subject to inference with moving parts such as the brake rotor or the wheel (i.e., the one or more clips and/or one or more springs are placed directly over the rotor). Additionally, while these one or more clips and/or one or more springs may increase a retraction force of the brake pads, the force is often not evenly applied to the brake pads. For example, the one or more clips and/or one or more springs may provide a retraction force greater than a frictional force between a first abutment feature and the brake pad (e.g., a pin), yet the retraction force may not be greater than a frictional force between a second abutment feature and the brake pad (e.g., an ear of the one or more brake pads guided along a channel). As a result, the one or more clips and/or one or more springs may not aid, or even deter, in preventing unwanted movement, tilting, rotation, pivoting, non-planar movement, or a combination thereof of the brake pads.

Examples of brake systems having a clip and/or spring are disclosed in U.S. Pat. Nos. 3,710,896; 4,219,105; 4,491,204; 5,249,647; 5,538,103; 6,378,665; 6,719,105; 7,308,974; 7,467,693; 8,376,092; 8,393,441; 8,397,880; 9,261,152; U.S. Patent Publication Nos. 2002/0189911; 2007/0246312; and 2016/0003315; and U.S. Design Pat. Nos. D483,709; and D489,655, all of which are incorporated by reference herein for all purposes. It would be attractive to have a brake system in which a retraction spring retracts the one or more brake pads guided by one or more abutment features. What is needed is a retraction spring that provides a retraction force greater than a frictional force between the one or more brake pads and the one or more abutment features. It would be attractive to have a retraction spring that prevents unwanted movement, tilting, rotation, pivoting, non-planar movement, or a combination thereof of the brake pads during release of the brake rotor. What is needed is a retraction spring that provides a retraction force on the one or more brake pads substantially axially away from the brake rotor. It would be attractive to have a retraction spring that is lightweight, durable, resistant to failure, and can be positioned within the brake system without interference with moving parts. What is needed is a lightweight retraction spring that elastically deforms during movement of the one or more brake pads and is positioned away from moving parts of the brake system (e.g., the brake rotor).

### SUMMARY

The present teachings meet one or more of the present needs by providing: a retraction spring comprising: (a) a body portion; (b) a first end; and (c) a second end, the second end connected to the first end via the body portion, wherein the retraction spring is configured to connect between mounting points of a caliper housing and attachment points along a bottom peripheral edge of one or more brake pad assemblies.

The present teachings meet one or more of the present needs by providing: a retraction spring comprising: (a) a first end; (b) an opposing second end; and (c) a body portion extending between the first end and the second end, wherein the first end and the second end include a finger having a contact point to connect to a component of a brake assembly.

The present teachings meet one or more of the present needs by providing: a brake assembly comprising: (a) a caliper housing; (b) two or more brake pad assemblies housed within the caliper housing, each brake bad assembly including a friction material disposed on a surface of a pressure plate; and (c) retraction springs, each retraction spring including: (i) a body portion; (ii) a first end; and (iii) a second end, the second end connected to the first end via the body portion, wherein each retraction spring connects a bottom portion of one or more of the two or more brake pad assemblies to a bottom portion of the caliper housing.

The present teachings provide a brake assembly having one or more retraction springs that retract one or more brake pads guided by one or more abutment features. The present teachings include a retraction spring that provides a retraction force greater than a frictional force between the one or more brake pads and the one or more abutment features. The present teachings provide a retraction spring that provides a retraction force on the one or more brake pads to prevent unwanted movement, tilting, rotation, pivoting, non-planar movement, or a combination thereof of the brake pads. The present teachings include a retraction spring that provides a retraction force axially away from the brake rotor. The present teachings provide a lightweight, durable, and robust retraction spring. The present teachings provide a retraction spring that elastically deforms during movement of the one or more brake pads and may be positioned away from moving parts of the brake system (e.g., the brake rotor).

### BRIEF DESCRIPTION OF THE DRAWINGS

FIG. 1 is a perspective view of a brake assembly having a plurality of retraction springs;

FIG. 2 is a bottom view of a brake assembly having a plurality of retraction springs;

FIG. 3 is a perspective view of a brake assembly having a plurality of retraction springs;

FIG. 4 is a bottom view of the brake assembly of FIG. 3 having a plurality of retraction springs;

FIG. 5 is a side view of a partial brake assembly;

FIG. 6 is a cross-sectional view of the partial brake assembly of FIG. 5 along line A-A;

FIG. 7 is a perspective view of the partial brake assembly of FIG. 5;

FIG. 8 is a perspective view of a retraction spring;

FIG. 9 is a perspective view of a retraction spring having a plurality of helical loop sets;

FIG. 10 is a perspective view of a retraction spring having a plurality of helical loop sets; and

FIG. 11 is a perspective view of a retraction spring having a helical loop set.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the description herein, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present teachings relate to a brake assembly configured to decelerate a vehicle, such as a car, truck, bus, train, airplane, or a combination thereof. The brake assembly may also be integrated into components used for manufacturing or other equipment that require a brake for deceleration of one or more components, such as a lathe, amusement park rides, wind turbines, metal stamping presses, conveyor systems, or a combination thereof. The brake assembly may include one or more stationary components and/or one or more moving components. The one or more stationary components may include a caliper housing, one or more mounting features, one or more brake pad assemblies, one or more abutment features, or a combination thereof. The one or more moving components may include one or more brake pad assemblies, one or more clips, one or more springs, or a combination thereof. The brake assembly may be positioned around a moving component so that one or more brake pad assemblies engage a surface of the moving component, causing the moving component to decelerate. For example, a caliper housing may receive a rotor within an opening of the caliper housing so that one or more brake pad assemblies located within the caliper housing axially move relative to the rotor provide a clamping force on opposing surfaces of the rotor. The brake assembly may include a leading end and a trailing end. The leading end may refer to an end where a point of the rotor passes through first during movement (i.e., the point of the rotor enters the brake assembly). Conversely, the trailing end may refer to an end where the point of the rotor passes through last during movement (i.e., after passing through the leading end when the rotor exits the brake assembly). The brake assembly may be in communication with a controller to electrically trigger activation (e.g., clamping) of the brake assembly. The brake assembly may be hydraulically activated by one or more hydraulic pressure lines. The brake assembly may include a caliper housing that is in communication with one or more brake pad assemblies.

The caliper housing may function to house one or more components of the brake assembly, such as one or more brake pad assemblies, abutment features, clips, springs, fasteners, or a combination thereof. The caliper housing may be in communication with the one or more components housed within the caliper housing. For example, the caliper housing may communicate with one or more brake pad assemblies to engage the one or more brake pad assemblies with a rotor of a vehicle. The caliper housing may include one or more pistons to drive one or more brake pad assemblies towards the rotor to create a clamping force. For example, the caliper may include an inboard piston and an outboard piston connected to an inboard and outboard brake pad assembly respectively for driving the brake pad assemblies towards the rotor (e.g., a fixed caliper). Alternatively, the caliper may include a single inboard piston to drive both an inboard brake pad assembly and an outboard brake pad assembly slidably engaged with the inboard brake pad assembly towards the rotor (e.g., a floating caliper). The caliper housing may include one or more openings so that a portion of the rotor is positioned within the confines of the caliper housing. For example, the caliper housing may include an opening along a bottom portion to receive a rotor so that opposing brake pad assemblies are positioned on opposing sides of the rotor. The caliper housing may include a bridge to connect opposing segments of the caliper housing (e.g., an inboard side and an outboard side). For example, an inboard side of the caliper housing having a first brake pad assembly may be integrally connected to an opposing outboard side of the caliper housing having a second brake pad assembly via the bridge. The caliper housing may include one or more mounting points to receive one or more clips, one or more springs, other components, or a combination thereof. The caliper housing may be configured to package one or more components of the brake assembly. The one or more components packaged within the caliper housing may include one or more brake pad assemblies, clips, springs, pistons, abutment features, support brackets (e.g., brackets that support and/or mount the brake assembly to the vehicle), or a combination thereof. For example, the caliper housing may have a profile so that one or more clips may fit within the caliper housing between the caliper housing and the support brackets, one or more brake pad assemblies, pistons, abutment features, or a combination thereof. The profile of the caliper housing may be configured based on packaging requirements within the vehicle, packaging requirements of components located within the caliper housing, or both. The caliper housing may be any geometry and size to accommodate a given application. The caliper housing may vary in size, shape, or both for packaging within a desired vehicle. The caliper housing may be integrally formed, or may be a set of separate pieces joined together. The caliper housing may include an interior contour substantially similar to one or more of the brake assembly components. For example, an interior surface of the caliper housing may be substantially similar to a shape of the one or more brake pad assemblies so that the caliper housing may receive the one or more brake pad assemblies.

The one or more brake pad assemblies may function to engage a rotor of the vehicle. The one or more brake pad assemblies may be configured to provide a clamping force on the rotor. The one or more brake pad assemblies may be in communication with the caliper housing or additional components to move the one or more brake pad assemblies. For example, the one or more brake pad assemblies may be in communication with one or more pistons located within the caliper housing to move the one or more brake pad assemblies towards the rotor, away from the rotor, or both. The one or more brake pad assemblies may move substantially axially relative to an axis of rotation of the rotor so that an engaging surface (e.g., a friction material) of the one or more brake pad assemblies is substantially parallel with a surface of the rotor, a rotor plane, or both. A plurality of one or more brake pad assemblies may be in communication to create a clamping force on the rotor. For example, a first brake pad assembly and an opposing second brake pad assembly may clamp opposing sides of the rotor to decelerate the vehicle. The first and second brake pad assemblies may move towards and away from the rotor. Alternatively, the first brake pad assembly may be stationary while the second brake pad assembly moves towards and away from the rotor, or vice versa (e.g., the caliper housing may be a fixed caliper housing or an opposed caliper housing). The one or more brake pad assemblies may include a friction material, a pressure plate, one or more abutment features, one or more springs, one or more clips, or a combination thereof.

A pair of opposing brake pad assemblies may be positioned on opposing sides of a rotor. For example, an inboard and an outboard brake pad assembly may maintain a gap between the brake pad assemblies when in a released position so that a portion of the rotor may be positioned within the gap. When the brake pad assemblies are applied (i.e., clamped), the gap between the brake pad assemblies decreases until the friction material of the brake pad assemblies contacts opposing sides of the rotor and creates a clamping force to decelerate the vehicle. When deceleration is complete, the opposing brake pad assemblies are retracted (i.e., released), and the gap between the brake pad assemblies increases substantially back to its initial position.

The one or more brake pad assemblies may be in communication with the caliper housing via a pressure plate. The pressure plate may function to structurally support one or more friction materials of the brake pad assembly. The pressure plate may be in communication with the caliper housing to move the brake pad assembly towards the rotor, away from the rotor, or both. For example, the pressure plate may be affixed to a piston of the caliper housing that extends and retracts the pressure plate, thereby extending and retracting the brake pad assembly. The pressure plate may have a shape substantially similar to one or more friction materials, or may be dissimilar. One or more friction materials may be disposed on, and joined to, a surface of the pressure plate. For example, the one or more friction materials may be disposed on a surface of the pressure plate so that the one or more friction materials are positioned between the pressure plate and the rotor, thereby allowing the one or more friction materials to contact the rotor. The one or more friction materials may be adhered, mechanically fastened, or both to the pressure plate. The one or more friction materials may be integrally formed with the pressure plate. A plurality of pressure plates may support a single friction material, or a plurality of friction materials may be supported by a single pressure plate. The pressure plate may include one or more attachment points to receive one or more clips, one or more springs, other components, or a combination thereof. The pressure plate may include one or more openings to interface with one or more abutment features of the brake assembly. The pressure plate may include one or more ears protruding from a peripheral edge, surface, or both of the pressure plate. The one or more openings, the one or more ears, or both may interface with one or more abutment features of the brake assembly to guide the one or more brake pad assemblies during movement.

The abutment interface between the one or more brake pad assemblies and one or more abutment features may function to guide the one or more brake pad assemblies during clamping, retraction, or both. The abutment interface may aid in maintaining a proper travel path of the one or more brake pad assemblies. For example, the abutment interface may guide the one or more brake pad assemblies in an axial direction relative to the axis of the rotor and substantially prevent rotational movement of the one or more brake pad assemblies. The abutment interface may include a male portion, a female portion, or both. For example, the abutment interface may include a pin (i.e., the male portion) secured to the caliper housing and received by an opening (i.e., the female portion) located on the pressure plate of the one or more brake pad assemblies. The abutment interface may create a frictional force between the one or more brake pad assemblies and the abutment features. The frictional force may be distributed evenly across the one or more brake pad assemblies, or may be distributed unevenly. For example, an abutment interface may only be located near a trailing end of a brake pad assembly so that the frictional force is only created near the trailing end. One or more lubricants or friction modifiers may be disposed on the male portion, female portion, or both of the abutment interface to decrease frictional force.

A plurality of abutment interfaces may be used with the one or more brake pad assemblies. For example, one or more abutment interfaces, two or more abutment interfaces, or three or more abutment interfaces may be used with the one or more brake pad assemblies. Additionally, six or less abutment interfaces, five or less abutment interfaces, or four or less abutment interfaces may be used with the one or more brake pad assemblies. Each brake pad assembly may include one or more abutment interfaces. Alternatively, only a portion of the one or more brake pad assemblies may include one or more abutment interfaces. The abutment interface may include one or more abutment features integrally formed with the caliper housing of the brake assembly.

The abutment features may function to abut one or more surfaces of the one or more brake pad assemblies, the caliper housing, or both. The abutment features may function to maintain an axial travel path of the one or more brake pad assemblies. The abutment features may be located along the one or more brake pad assemblies, the caliper housing, or both. For example, the abutment feature may be a pin mounted to the caliper housing and received by an opening on the pressure plate of a brake pad assembly so that the brake pad assembly is guided along the contour of the pin. The abutment features may be located at a leading end, a trailing end, or a location therebetween (e.g., between a top of the pressure plate and the bridge of the caliper). Alternatively, the abutment feature may be an ear protruding from a peripheral edge of the brake pad assembly so that the ear is guided along a channel integrally formed with an interior surface of the caliper housing. The abutment interface may include one or more abutment features that are fixedly attached to the caliper housing, the one or more brake pad assemblies, or both. The abutment features may be pins, channels, arms, fasteners, or a combination thereof. The abutment features may be guided along a track, channel, slot, path, or a combination thereof. Alternatively, an opening, hole, notch, edge, divot, contoured portion, or a combination thereof may be guided along the abutment feature. The abutment features may help maintain a position of one or more friction materials of the one or more brake pad assemblies during clamping and/or retraction of the one or more brake pad assemblies. The abutment features may work in conjunction with one or more top clips to maintain a position of one or more brake pad assemblies.

The top clip may function to communicate with the caliper housing, the pressure plates, or both and help maintain orientation of one or more brake pad assemblies. The top clip may be placed between opposing brake pad assemblies so that the brake pad assemblies are in communication with each other. The top clip may be positioned within the gap between brake pad assemblies and located near a leading end and/or a trailing end of the rotor. The top clip may bias the opposing brake pad assemblies away from each other. The top clip may help in maintaining an orientation of the brake pad assemblies. The top clip may create an opposing force when the brake pad assemblies are applied to the rotor. For example, as the gap between opposing brake pad assemblies is decreased during clamping of the rotor, the top clip compresses, creating an opposing retraction force on the brake pad assemblies away from the rotor. The top clip may be free of providing any forces parallel to the axis of rotation of the rotor. The top clip may only provide forces that are perpendicular to the axis of rotation of the rotor. For example, the top clip may create a force that pushes on a top of each brake pad assembly so that during running the brake pads assemblies are prevented from moving, but the top clip may be free of any forces in an axial direction relative to the axis of rotation of the rotor. The top clip may include one or more angles, one or more contoured portions, one or more projections, or a combination thereof. The top clip may be used in conjunction with one or more retraction springs, one or more pad clips, or both.

The pad clip may function to communicate between the friction material, the pressure plates, or both and one or more additional components of the brake assembly. The pad clip may function to communicate between an abutment feature of the brake pad assembly and a corresponding portion of the caliper housing, or vice versa. The pad clip may be placed between the abutment feature of the brake pad assembly and the caliper housing to maintain communication within the abutment interface (i.e., the interface between the abutment feature and the caliper housing). The pad clip may be placed between the brake pad assembly and one or more additional components of the brake assembly, such as a support bracket that supports the brake pad assembly. The pad clip may have one or more legs, one or more arms, or both. The pad clip may include a bridge extending between the one or more legs, one or more arms, or both. The pad clip may substantially conform to the shape of the abutment feature so that the pad clip attaches to the abutment feature. For example, the pad clip may be substantially shaped like an ear of the pressure plate so that the pad clip attaches to the ear, and the assembly of the pad clip and the ear are inserted into a channel of the caliper housing to guide the brake pad assembly during application and retraction. The pad clip may include one or more angles, one or more contoured portions, one or more projections, or a combination thereof. The pad clip may be used in conjunction with one or more top clips, one or more retraction springs, or both.

The retraction spring may function to create a retraction force on one or more brake pad assemblies. The retraction spring may function to communicate between the one or more brake pad assemblies and the caliper housing. The retraction spring may include one or more arms, one or more arcuate portions, one or more contact points, one or more fingers, one or more helical loop sets, or a combination thereof. The retraction spring may further include one or more energy storing portions to store energy during expansion and/or compression of the retraction spring. The retraction spring may elastically deform to store energy in the energy storing portions. For example, the retraction spring may be connected between a brake pad assembly and the caliper housing so that, when the brake pad assembly is applied and moves toward the rotor, the retraction spring is stretched to accommodate for the increase in gap between the caliper housing and the brake pad assembly. The retraction spring may plastically deform to maintain a retraction force on the one or more brake pad assemblies within a desired range. For example, as the friction material of the brake pad assembly wears during use, the distance between the brake pad assembly and the rotor may increase, and the retraction spring may plastically deform to accommodate for the increased travel distance of the brake pad assembly due to wear, thereby maintaining a substantially constant air gap, retraction force, or both within a desired range independent of the gap size between the brake pad assembly and the rotor.

The retraction spring may create a retraction force sufficient to retract the brake pad assembly away from the rotor. The retraction spring may provide a retraction force that aids in retracting the brake pad assembly and prevents tilting, rotating, pivoting, unwanted movement, or a combination thereof of the brake pad assembly. For example, the retraction spring may create a retraction force evenly distributed between ends of the brake pad assembly during retraction so that both ends of the brake pad assembly are retracted at a substantially similar pace. Alternatively, the retraction spring may create a retraction force unevenly distributed between ends of the brake pad assembly. For example, the retraction spring may be positioned near an abutment interface located at a first end of the brake pad assembly so that a greater portion of the retraction force is applied to the first end of the brake pad assembly and a smaller portion of the retraction force is applied at an opposing second end of the brake pad assembly. The retraction spring may create a retraction force less than, equal to, or greater than a frictional force of an abutment interface. The retraction spring may create a retraction force that is greater than a frictional force of an abutment interface so that, when retracted or applied, the brake pad assembly overcomes the frictional force without unwanted movement, tilting, rotating, pivoting, or a combination thereof. A single retraction spring may provide a retraction force greater than a sum of frictional forces from a plurality of abutment interfaces. A plurality of retraction springs may be used to retract a single brake pad assembly. Two or more retraction springs, three or more retraction springs, or four or more retraction springs may be used to retract a single brake pad assembly. Six or less retraction springs, five or less retraction springs, or four or less retraction springs may be used to retract a single brake pad assembly. Alternatively, a single retraction spring may retract a plurality of brake pad assemblies.

The retraction spring may vary in size, shape, or both based on a desire configuration of the retraction spring within the brake assembly. A plurality of retraction springs used in a brake assembly may be substantially similar in size, shape, or both, or may vary. For example, a first retraction spring may be substantially U-shaped while a second retraction spring may be a linear coil. The retraction spring may be V-shaped, U-shaped, W-shaped, S-shaped, or a combination thereof. The retraction spring may be substantially linear. The retraction spring may include a serpentine configuration. The retraction spring may be any material that assists in retracting one or more brake pad assemblies. The retraction spring may be any material that elastically deforms, plastically deforms, or both. The retraction spring may be any biasing device. The retraction spring may be any device that assists in moving (e.g., retracting) one or more brake pad assemblies axially in relation to the rotor, storing energy, or both. The retraction device may pre-load one or more brake pad assemblies with a retraction force so that rattle is substantially reduced and/or eliminated during running of the vehicle.

The retraction spring may create forces in one or more directions (e.g., force vectors). The one or more forces may be parallel to the axis of rotation of the rotor, piston bore axis, or both. The one or more forces may be at an angle relative to the piston bore axis, the axis of rotation of the rotor, or both. The retraction spring may only apply a force that is parallel or substantially parallel (e.g., within about 3 degrees or less, or within about 1 degree or less) with the axis of rotation of the rotor, the piston bore axis, or both. The retraction spring may apply a force in a direction so that the retraction spring assists in preventing rattle during brake off conditions. The retraction spring may create a retraction force having a force vector other than substantially perpendicular to the rotor plane. The retraction spring may create a retraction force having a force vector creating an angle of about 30 degrees or more relative to the rotor plane, about 45 degrees or more relative to the rotor plane, about 60 degrees or more relative to the rotor plane, or about 75 degrees or more relative to the rotor plane. The retraction spring may create a retraction force having a force vector creating an angle of about 160 degrees or less relative to the rotor plane, about 145 degrees or less relative to the rotor plane, about 130 degrees or less relative to the rotor plane, or about 115 degrees or less relative to the rotor plane. The retraction spring may create a retraction force of about 5 newtons or more, about 15 newtons or more, or about 30 newtons or more. The retraction spring may create a retraction force of about 60 newtons or less, about 45 newtons or less, or about 35 newtons or less. The retraction spring may create a retraction force substantially perpendicular to the rotor plane (i.e., axial relative to the axis of rotation of the rotor).

The retraction spring may create a plurality of retraction forces on the brake pad assembly. For example, a plurality of contact points of the retraction spring may be connected to attachment points of the brake pad assembly so that the retraction spring creates a retraction force near each attachment point. The plurality of retraction forces may be similar or may be different. For example, the retraction spring may be asymmetrical so that a first retraction force near a first end of the brake pad assembly may be greater than a second retraction force near an opposing second end of the brake pad assembly to accommodate for a frictional force of an abutment interface near the first end. Alternatively, the retraction spring may be symmetrical and connected to a single attachment point of the brake pad assembly so that the retraction spring provides a single retraction force on the brake pad assembly. The retraction spring may work in conjunction with one or more top clips, one or more pad clips, or a combination thereof. The retraction spring may be fixedly attached to one or more brake pad assemblies, the caliper housing, or both. For example, the retraction spring may be attached to, and connected between, the pressure plate of the brake pad assembly and the caliper housing. The retraction spring may not extend across the rotor (i.e., does not cross a rotor plane). The retraction spring may be dissected by a plane extending through a midpoint of one or more brake pad assemblies, the plane being substantially normal to the rotor plane. The retraction spring may be connected to the pressure plate, friction material, or both. The pressure plate, friction material, or both may include one or more attachment points that connect to one or more contact points of the retraction spring.

The attachment points may function to connect the one or more contact points of the retraction spring to one or more brake pad assemblies. The attachment points may function to secure one or more portions of the retraction spring so that during movement of the brake pad assembly, the retraction spring may elongate and/or compress. The attachment points may protrude from one or more peripheral edges of the friction material, the pressure plate, or both. The attachment points may protrude from a surface other than one or more peripheral edges. For example, the attachment points may protrude from a surface of the friction material, the pressure plate, or both, that is substantially parallel to the axis of rotation of the rotor. The attachment points may recess from a surface of the brake pad assemblies. The attachment points may be integrally formed with the brake pad assembly, or may be a secondary component secured to the brake pad assembly during manufacturing. The attachment points may include a shape that engages the one or more contact points of the retraction spring. The attachment points may include a mechanical interface to engage the one or more contact points of the retraction spring. The attachment points may be permanent (e.g., casting, welding, peening, adhering, fusing, soldering, bonding, fastening, or a combination thereof). The attachment points may be temporary so that the retraction spring may be replaced. For example, the attachment points may include a hook, latch, pin, button, clamp, clip, hole, recess, cavity, press-fit engagement (i.e., a shape of the contact point is larger than a receiving feature so that the contact point forcibly engages the receiving feature), or a combination thereof. The attachment points may include one or more adhesives, one or more fasteners, or both to secure the retraction spring to the attachment points. The attachment points may be positioned along a bottom edge of the brake pad assemblies. The bottom edge may be considered the peripheral edge of the friction material, the pressure plate, or both that is nearest the ground or floor that the vehicle rests and positioned near the opening of the caliper housing that receives a portion of the rotor (i.e., the bottom edge is located on an opposing side relative to the bridge of the caliper housing).

The attachment points may be positioned anywhere along the brake pad assembly between the leading end and the trailing end. For example, the attachment points may be located substantially near a midpoint between the leading end and the trailing end along the bottom edge of the pressure plate so that the attachment points are longitudinally centered along the brake pad assembly. Locating the attachment points near a midpoint between the leading end and the trailing end may allow the retraction spring to provide a pull force near the center of the brake pad assembly that evenly retracts both ends of the brake pad assembly (i.e., an end of the brake pad assembly nearest the trailing end and an opposing end of the brake pad assembly nearest the leading end). Alternatively, the attachment points may be positioned away from the center of the brake pad assembly near opposing ends of the brake pad assembly. For example, a first attachment point may be located near a trailing end of the brake pad assembly, and a second attachment point may be located near a leading end of the brake pad assembly, so that the retraction spring provides a first retraction force at the first attachment point and a second retraction force at the second attachment point. The first retraction force and the second retraction force may be substantially equal, or may be different. The attachment points may oppose one or more mounting points of the caliper housing so that the retraction spring extends between the brake pad assembly and the caliper housing.

The mounting points may function to connect the one or more contact points of the retraction spring to the caliper housing. The mounting points may be substantially similar in structure to the attachment points of the brake pad assemblies, or may be dissimilar. The mounting points may protrude from a surface of the caliper housing. For example, the mounting points may protrude from a bottom surface of the caliper housing that is substantially planar with the bottom edge of the brake pad assembly. The mounting points may include one or more fasteners, one or more adhesives, or both to secure the retraction spring to the mounting points. The mounting points may be positioned anywhere along the caliper housing between the leading end and the trailing end. The mounting points may be substantially in line with one or more attachment points so that the mounting points and the one or more attachment points are located at substantially the same position between the leading end and the trailing end of the brake assembly. One or more mounting points and one or more attachment points may be coplanar. The number of mounting points may be the same as the number of attachment points. For example, a single mounting point may be located on the caliper housing while a single opposing attachment point is located on the brake pad assembly. Alternatively, the number of mounting points may differ from the number of attachment points. For example, two or more mounting points may be located on the caliper housing while a single opposing attachment point is located on the brake pad assembly.

The distance between the mounting points and attachment points may increase as the gap between opposing brake pad assemblies decreases (i.e., during application of the brake pad assemblies). For example, when the brake pad assemblies are applied and the friction material makes contact with the rotor (i.e., the gap between the brake pad assemblies decreases), the retraction spring is elongated between the mounting points and attachments points, resulting in energy being stored in energy storing portions of the retraction spring, and providing a retraction force on the brake pad assembly. The mounting points may be positioned relative to the attachment points so that the retraction spring provides a retraction force on the brake pad assembly substantially axial relative to the axis of rotation of the rotor. The mounting points may be positioned relative to the attachment points so that the retraction spring provides a retraction force on the brake pad assembly having a force vector other than axial to the axis of rotation of the rotor. The mounting points may secure one or more contact points of the retraction spring.

The contact points may function to connect the retraction spring to one or more attachment points, one or more mounting points, or both. The contact points may be any location where the retraction spring contacts the mounting points, the attachment points, or both. The contact points may be a single point on each arm of the retraction spring (e.g., a cross-sectional end of the retraction spring material). Each arm of the retraction spring may have a contact point. For example, the retraction spring may include a plurality of arms each having a contact point, and a first arm may contact an attachment point on the brake pad assembly and one or more additional arms may contact mounting points on the caliper housing. The contact points may be a length of the retraction spring (e.g., the retraction spring may curve and form a finger off of the arms so that the entire length of the finger is in contact with an attachment point, a mounting point, or both). The contact points may contact an attachment point on a pressure plate of a brake pad assembly, a friction material of a brake pad assembly, or both. The contact points may contact a mounting point on the caliper housing. The contact points may contact a location other than a mounting point or attachment point. The contact points may include one or more holes to receive an engagement feature of the mounting points, the attachment points, or both. For example, a pin of the attachment points may extend through a pierced hole of the contact points. The contact points may include one or more adhesives to adhere the contact points to the attachment points, mounting points, or both. The contact points may include a lubricant, such as oil, grease, wax, or a combination thereof, to allow movement of the contact point when secured to the mounting points, the attachment points, or both. For example, the contact points may include a coating of oil to allow pivoting of the contact points within a receiving feature of the mounting points, the attachment points, or both. The lubricant may be a dry lubricant, a solid lubricant, or both. For example, the lubricant may be graphite, molybdenum disulfide, boron nitride, tungsten disulfide, or a combination thereof. The contact points may be structurally rigid. The contact points may be elastic so that the contact points flex and/or pivot during extension of the retraction spring, compression of the retraction spring, or both.

The contact points may extend from one or more arms of the retraction spring. The arms may function to connect one or more fingers and/or contact points with a body portion of the retraction spring. The arms may connect fingers, contact points, arcuate portions, energy storing portions, body portions, or a combination thereof. The arm portions may be straight. The arm portions may be arcuate. The arms may include one or more arcuate portions. For example, each arm may include two, three, four, five, six, or seven arcs formed in conjunction to create the arm. The arms may include a generally serpentine configuration. The arms may include one or more U-shaped portions. The U-shaped portions may be located juxtaposed to each other. The U-shaped portions may face in opposite directions.

The shape of the arms may be any shape that allows the retraction spring to assist in retracting one or more brake pad assemblies. For example, the arms may be any shape that allows the retraction spring to contact the mounting points of the caliper housing and the attachment points of one or more brake pad assemblies without contacting moving parts of the brake assembly (e.g., the rotor). The arms may be any shape that allows desired movement (e.g., vertical, horizontal, diagonal, rotational, or a combination thereof) of the retraction spring to allow the retraction spring to extend and retract during application and release of the brake pad assemblies. The arms may be long enough to extend between the mounting points and attachment points. The entire length of each arm may be coplanar. The arms may form one or more arm planes (e.g., a first arm plane, a second arm plane, or more). The arms may extend from a body portion and at least one arcuate portion of each arm may curve out of the plane of the body portion, the first arm plane, or both so that the arm portion creates a second arm plane adjacent to the plane of the body portion, the first arm plane, or both. The arms may have multiple planes. The arms may have two, three, four, five, or six planes. The arms may include one or more arcuate portions that curve the arms up or down relative to the body portion. The arms may be coplanar with the body portion. The arms may substantially be in a different plane than the body portion. The arms may be substantially similar in shape or different. The arms may be symmetrical or asymmetrical. For example, each arm of the retraction spring may be substantially the same length so that each arm provides a substantially similar retraction force on the brake pad assembly. Alternatively, the arms may be dissimilar in length so that each arm provides a different retraction force on the brake pad assembly. For example, a first arm connected to a trailing end of the brake pad assembly may be longer than a second arm connected to a leading end of the brake pad assembly, so that the second arm provides a retraction force greater than the first arm.

The arms may be at an angle relative to the body portion. There may be an angle between a first plane and a second plane (e.g., between the arms and the body portion or a first portion of the arms and a second portion of the arms). The angle between the arms and the body portion may be any angle that allows the retraction spring to connect between one or more brake pad assemblies and the caliper housing. The angle between the arms and the body portion may be any angle that allows the retraction spring to assist in retracting the one or more brake pad assemblies. The arms may be coplanar with the body. The angle between the arms and the body portion may be about 15 degrees or greater, about 30 degrees or greater, about 45 degrees or greater, about 60 degrees or greater, or about 75 degrees or greater. The angle between the arms and the body portion may be about 165 degrees or less, about 150 degrees or less, about 135 degrees or less, about 120 degrees or less, or about 105 degrees or less.

The arms may include or be separated by one or more arcuate portions. The arcuate portions may function to connect a plurality of arms. The arcuate portions may function to provide an energy storing portion during extension and compression of the retraction spring. The arcuate portions may function to connect the arms to the body portion. The arcuate portions may be any angle that allows the retraction spring to contact the mounting points of the caliper housing, the attachment points of one or more brake pad assemblies, or both. The arcuate portions between the arms may vary depending on the condition of the brake pad assemblies. For example, if the brake pad assemblies are new (i.e., the friction material has not yet been used or worn), the angle may be smaller because the travel distance required to contact the rotor is smaller (i.e., the friction material has a greater thickness and thus contacts the rotor sooner during application). However, if the friction material is fully worn the angle of the arcuate portions may be greater. For example, when the friction material is fully worn, the friction material has a smaller thickness and thus requires additional travel distance to contact the rotor. To accommodate for the additional travel distance, the brake pad assembly may adjust its initial position (i.e., its home position prior to application) to be closer to the rotor. By adjusting the initial position, the retraction spring may be extended an additional length, thereby increasing one or more angles of the arcuate portions.

The arcuate portions may form an angle between the arms of about 150 degrees or less, about 135 degrees or less, about 115 degrees or less, or about 90 degrees or less. The angle between the arms may be about 15 degrees or more, about 25 degrees or more, about 40 degrees or more, or about 60 degrees or more (i.e. about 67 degrees). The angle of the arcuate portions between arms may change (i.e. deform) by about 1 degree or more, about 3 degrees or more, about 5 degrees or more, or about 7 degrees or more as the brake pad assemblies wear. The angle between the arms may change (i.e. deform) by about 15 degrees or less, about 12 degrees or less, about 10 degrees or less, or about 8 degrees or less. Thus, for example, if the retraction spring has an arcuate portion between the arms having an angle of about 55 degrees when employed with new brake pad assemblies the angle may be about 63 degrees when the brake pad assemblies are fully worn (i.e., the angle may change about 8 degrees). The arcuate portions may extend from the arms and form a finger that terminates at a contact point of the retraction spring.

The finger may function to connect a contact point to the retraction spring. The finger may function to secure the retraction spring to the attachment points, the mounting points, or both in addition to the contact points. For example, the finger may be inserted into an attachment point, a mounting point, or both to hold the retraction spring in place. The finger may include a contact point at an end of the finger. The finger may form an angle relative to the portion of the arm to which is connects. The angle between the arm and the finger may be any angle so that the contact point of the finger holds the retraction spring in place when connected to a mounting point, an attachment point, or both and the retraction spring is able to assist in retracting the brake pad assemblies. The angle between the arm and the finger may be about 30 degrees or greater, about 45 degrees or greater, about 60 degrees or greater, or about 75 degrees or greater. The angle between the arm and the finger may be about 150 degrees or less, about 135 degrees or less, about 120 degrees or less, or about 105 degrees or less. The angle between the arm and the finger may be a substantially right angle. The fingers may work in conjunction with one or more energy storing portions during extension and/or compression of the retraction spring.

The energy storing portions may function to store energy during extension and/or compression of the retraction spring. The energy storing portions may function to store a retraction force applied to one or more brake pad assemblies. The energy storing portions may be at any point on the body portion, the arms, the arcuate portions, the fingers, or a combination thereof. The energy storing portions may be any configuration so that the retraction spring is compressed and/or bent, and the compression and/or bending (i.e., an angle of an arcuate portion between arms is changed) may be used to move the brake pad assemblies in a retraction direction (i.e., axially away from the rotor). The energy storing portions may use any of the features and movements discussed herein to describe the configuration and functionality of the energy storing portions. The energy storing portions may be one or more arcuate portions. The energy storing portions may elastically deform. For example, the energy storing portions may extend during application of the one or more brake pad assemblies, yet return to an initial position and/or form after the retraction force stored in the energy storing portions is applied to the one or more brake pad assemblies and the brake pad assemblies are moved in the retraction direction. The energy storing portions may be a unitary part of the spring. The energy storing portions may be any configuration that assists in retracting one or more brake pad assemblies. For example, the energy storing portions may be a “V” shape, an “S” shape, a loop, a triangle, a circle, a square, an elastomeric piece that is compressed, an arcuate portion in the body portion, an arcuate portion in the arms, or a combination thereof.

The energy storing portions may be a helical loop set. The helical loop set may function to store energy during a brake pad assembly application and release the energy during a brake pad assembly release so that one or more brake pad assemblies are retracted. The helical loop set may be successively stacked so that one loop is located directly adjacent to another loop. The helical loop set may include an axis that extends through the set of helical loops (e.g., eight helical loops or more share an axis). The helical loop set may be conical in shape. The helical loop set may be staggered so that the loops are not concentric, not coaxial, or both. The helical loop set may include loops of substantially the same size but staggered so that a common axis runs through the center of all of the loops diagonally at an angle relative to an axis of rotation of the rotor. One or more helical loop sets may be incorporated into the retraction spring. For example, the retraction spring may include a single helical loop set having a set of fingers at opposing ends so that retraction spring extends between a brake pad assembly and the caliper housing. Alternatively, the retraction spring may include a plurality of helical loop sets extending between the body portion and one or more arms of the retraction spring. The helical loop set may be any configuration where a portion of the retraction spring generally curves back over itself. The helical loop set may be configured so that each of the helical loops stores energy during a brake apply and releases energy when the brake apply is complete so that the released energy assists in retracting one or more brake pad assemblies. For example, each of the helical loops may be substantially similar in size so that, as the retraction spring is extended, the retraction force increases due to more helical loops within the retraction spring being extended. Alternatively, the helical loops may gradually increase in cross-sectional length from a distal end to a proximal end of the retraction spring (or vice versa) so that, as the retraction spring is extended, the retraction force may vary proportionally to the extension distance due to a variation in retraction forces between helical loops.

The loops within the helical loop set may be generally circular, oval, or both. The helical loop set may have about 2 loops or more, about 3 loops or more, about 4 loops or more, or about 5 loops or more. The helical loop set may have about 20 loops or less, about 15 loops or less, or about 10 loops or less. A cross-sectional length of each helical loop may be different or may be similar (i.e., the cross-sectional length of the helical loop set may vary or may be substantially constant). The cross-sectional length may be about 2 mm or more, about 5 mm or more, or about 10 mm or more. The cross-sectional length may be about 20 mm or less, about 15 mm or less, or about 12 mm or less. Each of the helical loops during a brake apply may be moved so that the loops store energy. The helical loops may be moved during a brake apply so that the helical loop set is compressed (i.e., the individual loops are moved closer to each other). The helical loop sets may be extended into tension during a brake apply so that gaps are formed between the helical loops. The gap between helical loops may be the same or different. For example, a first gap between individual helical loops may be greater than a second gap between two additional helical loops. The gap between helical loops may increase during application of the brake pad assemblies and may decrease during release of the brake pad assemblies (i.e., during retraction of the brake pad assemblies), or vice versa.

The helical loop set may be moved in a brake apply direction, a brake release direction, or both. The entire set of helical loops or a part of the group of helical loops may be moved in the brake apply direction, the brake retraction direction, or both. For example, the helical loop set may move substantially axially towards and/or away from an axis of rotation of the rotor. The helical loop set may move at a direction other than substantially axial relative to the axis of rotation of the rotor. The helical loop set may move at an angle relative to the axis of rotation of the rotor of about 30 degrees or greater, about 45 degrees or greater, about 60 degrees or greater, or about 75 degrees or greater. The helical loop set may move at an angle relative to the axis of rotation of the rotor of about 150 degrees or less, about 135 degrees or less, about 120 degrees or less, or about 105 degrees or less. The helical loop set may be free of movement in the brake apply direction, the brake release direction, or both. The helical loop set may move in a retraction spring compression direction, a retraction spring expansion direction, or both. The helical loop set may be connected to a body portion of the retraction spring.

The body portion may function to connect the arms, arcuate portions, contact points, fingers, energy storing portions, or a combination thereof. The body portion may include one or more: arms, arcuate portions, contact points, fingers, energy storing portions, or a combination thereof. The body portion may be arcuate. The body portion may be generally coplanar. The body portion may be substantially straight but may include one or more arcs (i.e., arcuate portions) so that the body portion may be one unitary piece. For example, the body portion may be generally straight but include a plurality of arcuate portions that are in combination so as to create a part of the body portion. The body portion may include one or more helical loops, one or more helical loop sets, or both. The body portion may include a serpentine configuration. The body portion may extend away from the rotor. For example, one or more arms of the body portion may be closer to the rotor than the body portion. The body portion may not extend across the rotor (i.e., the body portion does not cross a rotor plane).

The body portion may form a plane (i.e., a body plane). The body portion may form a plane and the arms may form a different plane or different planes. For example, the body plan may end when a new plane begins (e.g., the arms curve and begin a new plane). The entire body portion may be in the body plane. The body may form and be located in more than one plane. For example, the body portion may include an arcuate section that forms a second body plane separate from the first body plane. The second body plane may be substantially parallel to the first body plane. The second body plane may be substantially perpendicular to the first body plane.

The body portion may have a length. The length of the body portion may be measured from a distal end of the body portion to an opposite end of the body portion where the body portion terminates and the arms are formed. For example, the body portion may measure from the tip of the body portion (i.e., the distal end) to the end of the body portion (i.e., the point where an arcuate portion curves out of the body plane forming the arms). The length of the body portion may be constant (i.e., the length does not change during application of the one or more brake pad assemblies, during retraction of the one or more brake pad assemblies, or both). The length of the body portion may change. For example, the length of the body portion may increase during application of the one or more brake pad assemblies and decrease during release and/or retraction of the one or more brake pad assemblies, or vice versa. The body portion may be the shortest when the brake pad assemblies are in a retract position (i.e., when the one or more brake pad assemblies are not in contact with the rotor). The length of the body portion may be directly proportional to an angle between the arms formed by one or more arcuate portions. For example, as the angle decrease, the length of the body portion may also decrease.

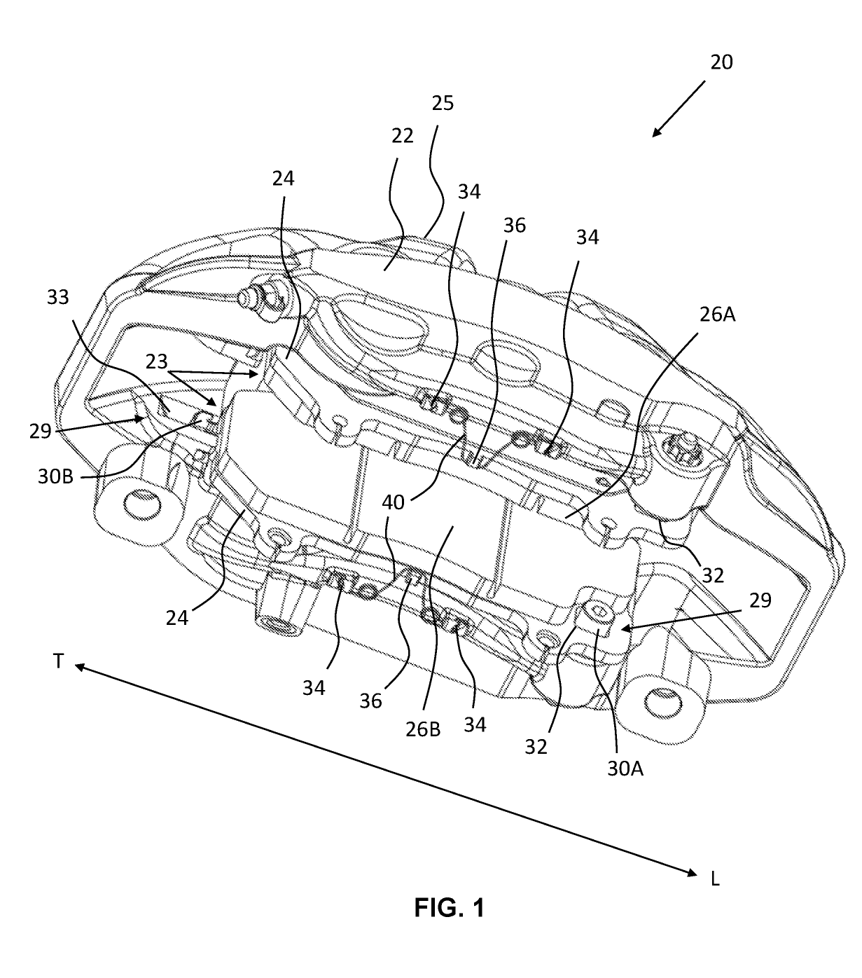

Turning now to the figures, FIG. 1 illustrates a perspective view of a brake assembly 20 having a plurality of brake pad assemblies 23. The brake pad assemblies 23 are positioned within a caliper housing 22 and include a friction material 26 disposed on a pressure plate 24. A bridge 25 is located along a top portion of the caliper housing 22, extending from a leading end (L) to a trailing end (T) of the brake assembly 20. An outboard friction material 26A and an inboard friction material 26B centered between the leading end (L) and the trailing end (T) movably oppose one another so that the friction materials 26 may provide a clamping force on a rotor (not shown) by decreasing a gap between the brake pad assemblies 23 (see FIG. 6). The brake pads assemblies 23 are guided during movement via a plurality of abutment interfaces 29 having an abutment feature 30. A first configuration of the abutment interface 29 guides the brake pad assemblies 23 along a pin 30A extending through an opening 32 of the pressure plates 24. A second configuration of the abutment interface 29 guides an ear 30B of the brake pad assemblies 23 along a channel 33 of the caliper housing 22. Retraction springs 40 are connected between a plurality of mounting points 34 on the caliper housing 22 and an attachment point 36 located on a bottom edge of the pressure plates 24. The retraction springs 40 are substantially centered on an axis of rotation (A_{R}) of the rotor, the axis of rotation (A_{R}) being located substantially near a midpoint between the leading end (L) and the trailing end (T) of the brake assembly 20. As the gap between the brake pad assemblies 23 is decreased, the retraction springs 40 are extended to store a retraction energy. When the brake pad assemblies 23 are released (i.e., the gap is increased), the stored retraction energy within the retraction springs 40 is released to aid in retracting the brake pad assemblies 23 back to their initial position.

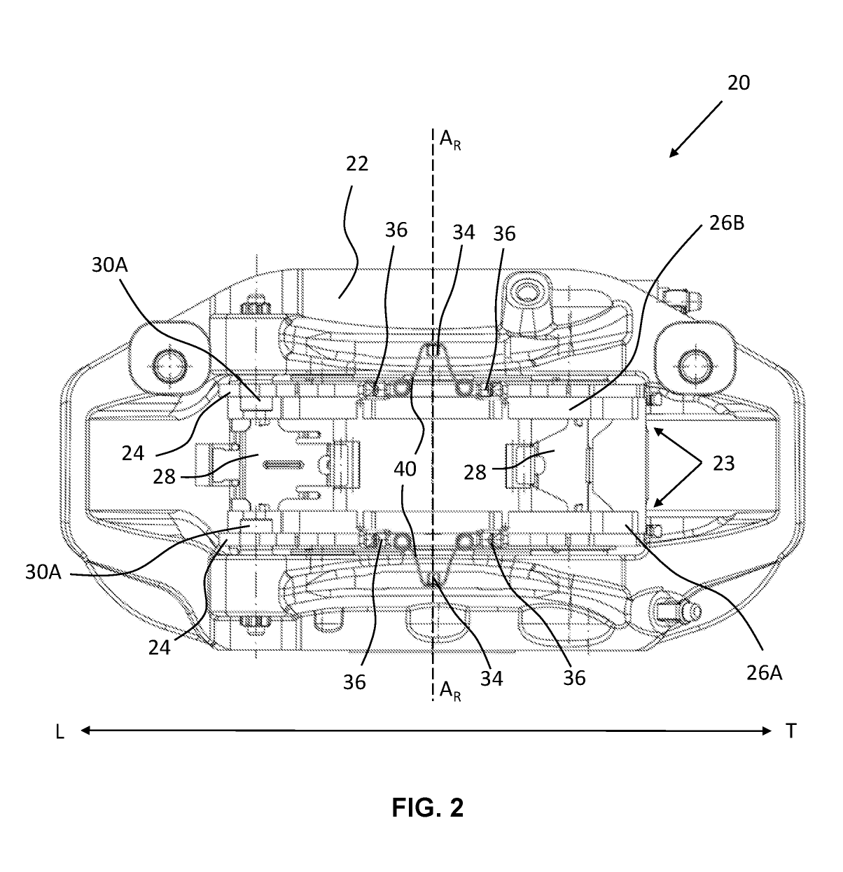

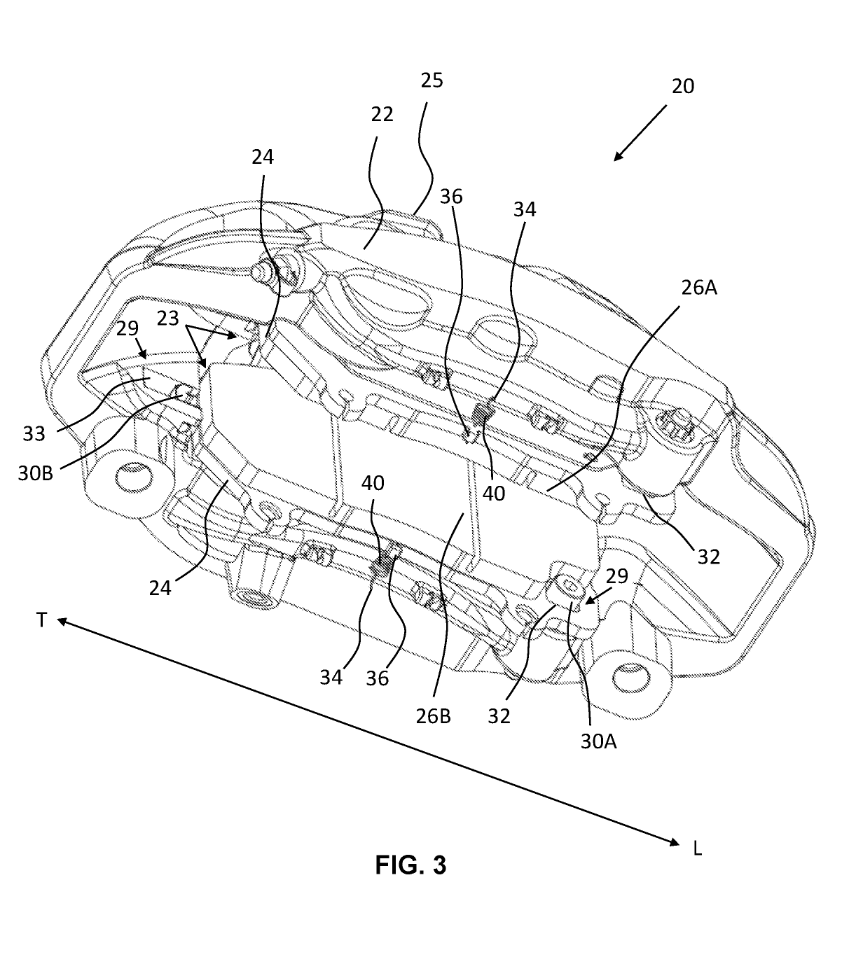

FIG. 2 illustrates a bottom view of a brake assembly 20 having a plurality of brake pad assemblies 23. The brake pad assemblies 23 are positioned within a caliper housing 22 and include a friction material 26 disposed on a pressure plate 24. A bridge is located along a top portion of the caliper housing 22, extending from a leading end (L) to a trailing end (T) of the brake assembly 20 (see FIGS. 1 and 3). An outboard friction material 26A and an inboard friction material 26B centered between the leading end (L) and the trailing end (T) movably oppose one another so that the friction materials 26 may provide a clamping force on a rotor (not shown) by decreasing a gap between the brake pad assemblies 23 (see FIG. 6). The brake pads assemblies 23 are guided during movement via a plurality of abutment interfaces having an abutment feature 30 (see FIGS. 1 and 3). A first configuration of the abutment interface guides the brake pad assemblies 23 along a pin 30A extending through an opening 32 of the pressure plates 24. Retraction springs 40 are connected between a mounting point 34 on the caliper housing 22 and a plurality of attachment points 36 located on a bottom edge of the pressure plates 24. The retraction springs 40 are substantially centered on an axis of rotation (A_{R}) of the rotor, the axis of rotation (A_{R}) being located substantially near a midpoint between the leading end (L) and the trailing end (T) of the brake assembly 20. As the gap between the brake pad assemblies 23 is decreased, the retraction springs 40 are extended to store a retraction energy. When the brake pad assemblies 23 are released (i.e., the gap is increased), the stored retraction energy within the retraction springs 40 is released to aid in retracting the brake pad assemblies 23 back to their initial position. Additionally, top clips 28 positioned between the brake pad assemblies 23 work in conjunction with the retraction springs 40 to retract the brake pad assemblies 23.

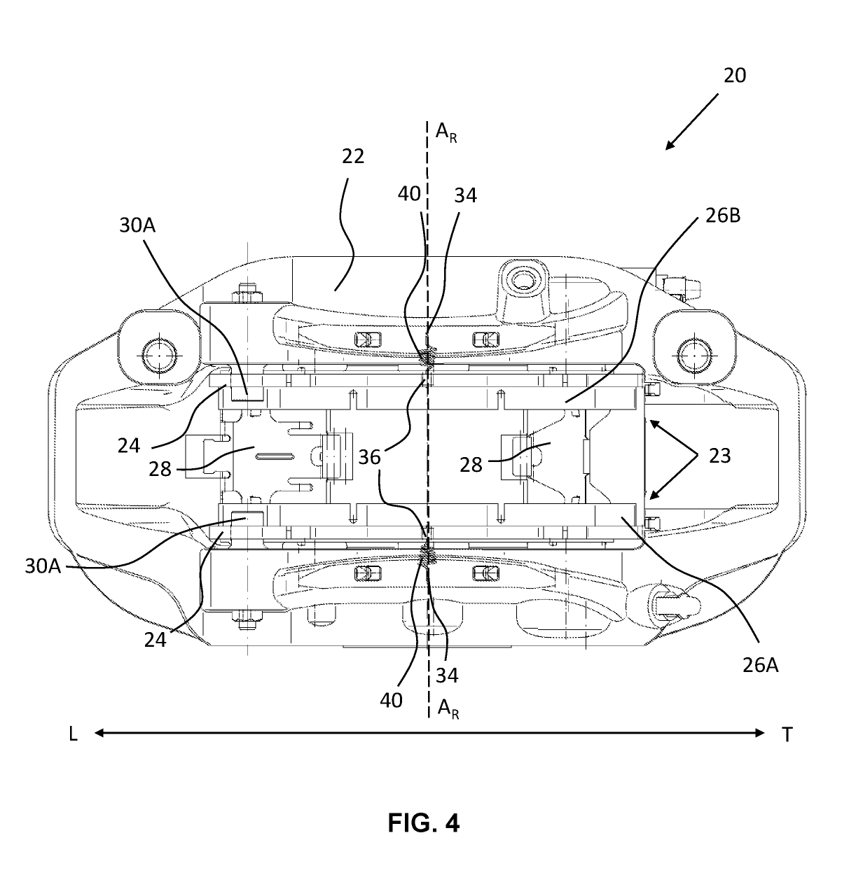

FIGS. 3 and 4 illustrate a perspective view and a bottom view respectively of a brake assembly 20 having a plurality of brake pad assemblies 23. The brake pad assemblies 23 are positioned within a caliper housing 22 and include a friction material 26 disposed on a pressure plate 24. A bridge 25 is located along a top portion of the caliper housing 22, extending from a leading end (L) to a trailing end (T) of the brake assembly 20. An outboard friction material 26A and an inboard friction material 26B centered between the leading end (L) and the trailing end (T) movably oppose one another so that the friction materials 26 may provide a clamping force on a rotor (not shown) by decreasing a gap between the brake pad assemblies 23 (see FIG. 6). The brake pad assemblies 23 are guided during movement via a plurality of abutment interfaces 29 having an abutment feature 30. A first configuration of the abutment interface 29 guides the brake pad assemblies 23 along a pin 30A extending through an opening 32 of the pressure plates 24. Retraction springs 40 are connected between a mounting point 34 on the caliper housing 22 and an attachment point 36 located on a bottom edge of the pressure plates 24. A second configuration of the abutment interface 29 guides an ear 30B of the brake pad assemblies 23 along a channel 33 of the caliper housing 22. The retraction springs 40 are substantially centered on an axis of rotation (A_{R}) of the rotor, the axis of rotation (A_{R}) being located substantially near a midpoint between the leading end (L) and the trailing end (T) of the brake assembly 20. As the gap between the brake pad assemblies 23 is decreased, the retraction springs 40 are extended to store a retraction energy. When the brake pad assemblies 23 are released (i.e., the gap is increased), the stored retraction energy within the retraction springs 40 is released to aid in retracting the brake pad assemblies 23 back to their initial position. As shown in FIG. 4, top clips 28 positioned between the brake pad assemblies 23 work in conjunction with the retraction springs 40 to retract the brake pad assemblies 23.

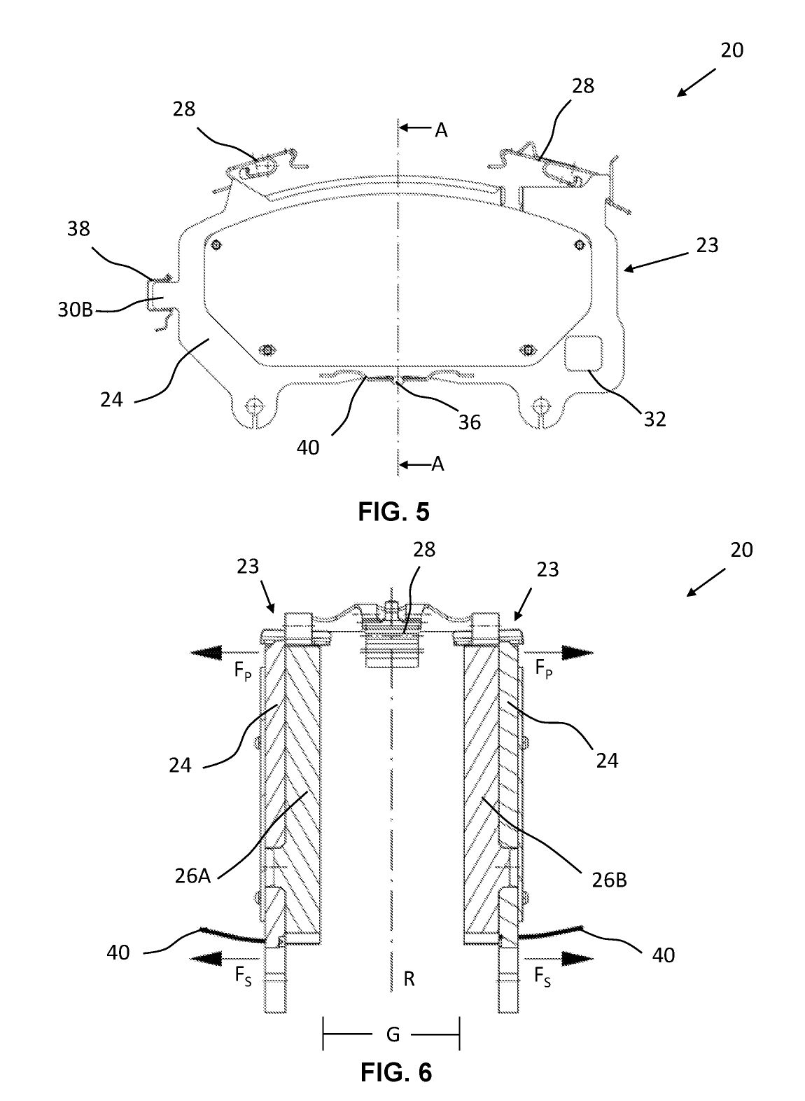

FIG. 5 illustrates a side view of a partial brake assembly 20. A friction material is disposed on a surface of a pressure plate 24 having an opening 32 so that a brake pad assembly 23 is guided along a pin extending through the opening 32 (see FIGS. 1-4). Top clips 28 abut a top portion of the pressure plate 24 to maintain a position of the brake pad assembly 23. A pad clip 38 engaging an abutment feature 30 that is an ear 30B of the pressure plate 24 also aids in maintaining the position of the brake pad assembly 23 during movement relative to a channel of a caliper housing (see FIGS. 1-4). A retraction spring 40 is connected to an attachment point 36 located on a bottom peripheral edge of the pressure plate 24 centered along a midpoint between the leading end and the trailing end of the brake pad assembly 23 (see FIGS. 1-4).

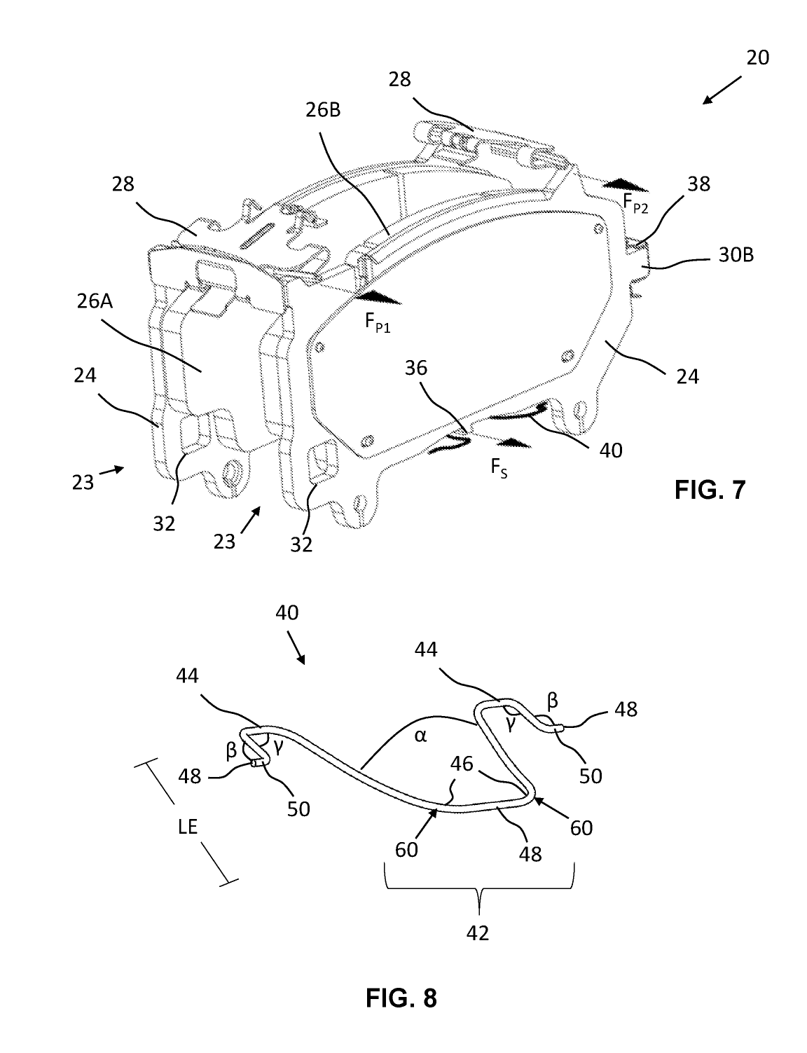

FIGS. 6 and 7 illustrate a cross-sectional view along line A-A and a perspective view respectively of the partial brake assembly 20 of FIG. 5. The partial brake assembly 20 includes opposing brake pad assemblies 23 abutting top clips 28. Each brake pad assembly 23 includes a friction material 26 disposed on a pressure plate 24. The brake pad assemblies 23 are guided along a pin extending through an opening 32 of the pressure plates 24 (see FIGS. 1-4). An outboard friction material 26A and an inboard friction material 26B movably oppose one another so that the friction materials 26 may provide a clamping force on a rotor (not shown) by decreasing a gap (G) between the brake pad assemblies 23. Retraction springs 40 are connected between a mounting point on a caliper housing and an attachment point 36 located on a bottom edge of the pressure plates 24 (see FIGS. 1-4). As the gap (G) between the brake pad assemblies 23 is decreased, the retraction springs 40 are extended to store a retraction energy. When the brake pad assemblies 23 are released (i.e., the gap is increased), the stored retraction energy within the retraction springs 40 is released to provide a force (F_{S}) to aid in retracting the brake pad assemblies 23 back to their initial position. The top clips 28 positioned between the brake pad assemblies 23 work in conjunction with the retraction springs 40 to retract the brake pad assemblies 23 by providing an additional balancing force (F_{P}). As shown in FIG. 7, each top clip 28 provides a counterbalancing force (F_{P1} and F_{P2}) in substantially the same direction as the retraction spring force (F_{S}) to prevent movement of the brake pad assemblies 23 not substantially perpendicular to a rotor plane (R) of the rotor, such as tilting or rotation of the brake pad assemblies 23. A pad clip 38 engaging an abutment feature 30 that is an ear 30B of the pressure plate 24 also aids in maintaining the position of the brake pad assembly 23 during movement relative to a channel of a caliper housing (see FIGS. 1-4).

FIG. 8 illustrates a perspective view of a retraction spring 40. The retraction spring 40 includes a body portion 42, one or more arms 44, one or more arcuate portions 46, and one or more contact points 48. Each arm 44 having an angle (γ) includes a finger 50 and a contact point 48 at the end of each finger 50 forming an angle (β) with each arm 44. The retraction spring 40 further includes energy storing portions 60 that retain energy when the retraction spring 40 is extended. For example, as a length (LE) of the retraction spring 40 increases and an angle (α) between opposing arms 44 decreases during a clamping of the brake pad assemblies, energy is stored in the energy storing portions 60. When the retraction spring 40 is released and angle (α) is increased, the stored energy is released and the retraction spring 40 returns to its original position. During retraction and release of the retraction spring 40, angle (α), angle (β), angle (γ), or a combination thereof may increase or decrease so that energy is stored in the energy storing portions 60.

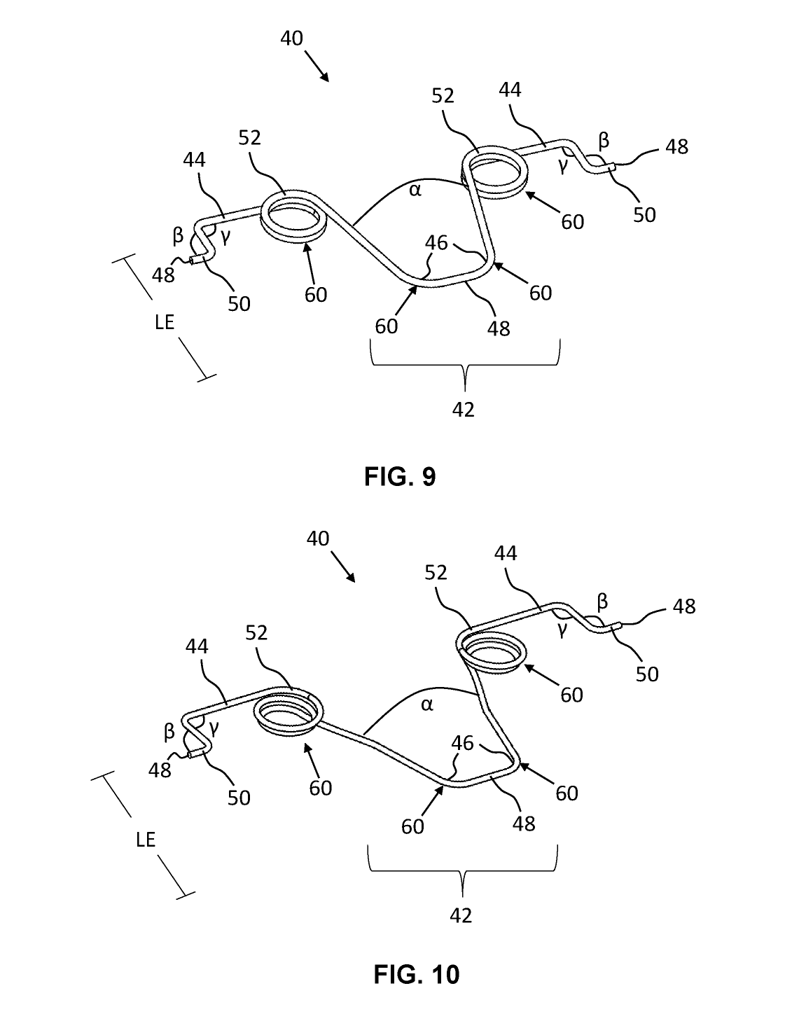

FIG. 9 illustrates a perspective view of a retraction spring 40. The retraction spring 40 includes a body portion 42, one or more arms 44, one or more arcuate portions 46, and one or more contact points 48. Each arm 44 having an angle (γ) includes a finger 50 and a contact point 48 at the end of each finger 50 forming an angle (β) with each arm 44. The retraction spring 40 further includes energy storing portions 60 that retain energy when the retraction spring 40 is extended. For example, as a length (LE) of the retraction spring 40 increases and an angle (α) between opposing arms 44 decreases during a clamping of the brake pad assemblies, energy is stored in the energy storing portions 60. When the retraction spring 40 is released and angle (α) is increased, the stored energy is released and the retraction spring 40 returns to its original position. During retraction and release of the retraction spring 40, angle (α), angle (β), angle (γ), or a combination thereof may increase or decrease so that energy is stored in the energy storing portions 60. The energy storing portions 60 may include one or more helical loop sets 52 having a plurality of helical loops with a substantially similar diameter to form a cylindrical shape.

FIG. 10 illustrates a perspective view of a retraction spring 40. The retraction spring 40 includes a body portion 42, one or more arms 44, one or more arcuate portions 46, and one or more contact points 48. Each arm 44 having an angle (γ) includes a finger 50 and a contact point 48 at the end of each finger 50 forming an angle (β) with each arm 44. The retraction spring 40 further includes energy storing portions 60 that retain energy when the retraction spring 40 is extended. For example, as a length (LE) of the retraction spring 40 increases and an angle (α) between opposing arms 44 decreases during a clamping of the brake pad assemblies, energy is stored in the energy storing portions 60. When the retraction spring 40 is released and angle (α) is increased, the stored energy is released and the retraction spring 40 returns to its original position. During retraction and release of the retraction spring 40, angle (α), angle (β), angle (γ), or a combination thereof may increase or decrease so that energy is stored in the energy storing portions 60. The energy storing portions 60 may include one or more helical loop sets 52 having a plurality of helical loops decreasing in diameter to form a conical shape.

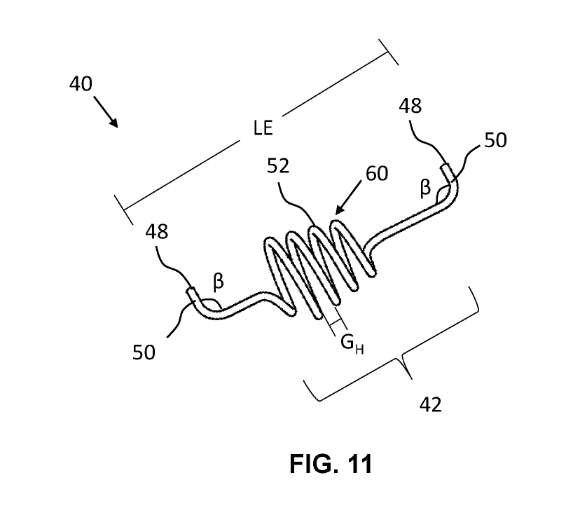

FIG. 11 illustrates a perspective view of a retraction spring 40. The retraction spring 40 includes a body portion 42 having a helical loop set 52, the helical loop set 52 including a plurality of helical loops decreasing in diameter to form a conical shape. The body portion 42 further includes fingers 50 forming an angle (β) with the body portion 42, and a contact point 48 at the end of each finger 50. The helical loop set 52 is an energy storing portion 60 that retains energy when the retraction spring 40 is extended. For example, as a length (LE) of the retraction spring 40 is increased during a clamping of the brake pad assemblies, gaps (G_{H}) between helical loops are increased, and energy is stored in the energy storing portion 60. When the retraction spring 40 is released (i.e., the length (LE) is decreased), the helical loops retract to decrease the gaps (G_{H}) and the stored energy is released so that the retraction spring 40 returns to its original position.

1. A retraction spring comprising:
a) a body portion;
b) a first end; and
c) a second end, the second end connected to the first end via the body portion,
wherein the retraction spring is configured to connect between mounting points of a caliper housing and attachment points along a bottom peripheral edge of one or more brake pad assemblies.

2. The retraction spring according to claim 1, further comprising one or more energy storing portions located in the body portion, the first end, the second end, or a combination thereof.

3. The retraction spring according to claim 2 wherein the one or more energy storing portions store energy during a brake apply to move the one or more brake pad assemblies in a retract direction away from a rotor plane.

4. The retraction spring according to claim 1, further comprising one or more helical loop sets.

5. The retraction spring according to claim 1, wherein the retraction spring is free of helical loop sets.

6. The retraction spring according to claim 1, wherein the first end, the second end, and the body portion are coplanar.

7. A retraction spring comprising:
a) a first end;
b) an opposing second end; and
c) a body portion extending between the first end and the second end,
wherein the first end and the second end include a finger having a contact point to connect to a component of a brake assembly.

8. The retraction spring according to claim 1, wherein the mounting points, the attachment points, or both are hooks.

9. The retraction spring according to claim 1, wherein the retraction spring stores energy during a brake apply and exerts a retraction force on the one or more brake pad assemblies near a midpoint of each of the one or more brake pad assemblies to retract the one or more brake pad assemblies away from a rotor.

10. The retraction spring according to claim 9, wherein ends of the one or more brake pad assemblies are free of contact with the retraction spring so that the retraction force is applied near the midpoint of each of the one or more brake pad assemblies.

11. A brake assembly comprising:
a) a caliper housing;
b) two or more brake pad assemblies housed within the caliper housing, each brake pad assembly including a friction material disposed on a surface of a pressure plate; and
c) retraction springs, each retraction spring including:
i. a body portion;
ii. a first end; and
iii. a second end, the second end connected to the first end via the body portion,
wherein each retraction spring connects a bottom portion of one or more of the two or more brake pad assemblies to a bottom portion of the caliper housing.

12. The brake assembly according to claim 11, wherein the first end of each retraction spring contacts a mounting point of the caliper housing and the second end of each retraction spring contacts an attachment point along a bottom peripheral edge of the two or more brake pad assemblies.

13. The brake assembly according to claim 11, wherein the first end and the second end of each retraction spring contact mounting points of the caliper housing and a middle contact point along the body portion contacts an attachment point along a bottom peripheral edge of the two or more brake pad assemblies.

14. The brake assembly according to claim 11, wherein the first end of each retraction spring contacts an attachment point along a bottom peripheral edge of the two or more brake pad assemblies and the second end of each retraction spring contacts a mounting point of the caliper housing.

15. The brake assembly according to claim 11, wherein each retraction spring is free of components extending beyond a rotor plane.

16. The brake assembly according to claim 11, wherein each retraction spring is free of components extending beyond the two or more brake pad assemblies toward a rotor of the brake assembly.

17. The retraction spring according to claim 1, wherein the retraction spring stores energy during a brake apply and exerts a retraction force on the one or more brake pad assemblies to retract the one or more brake pad assemblies away from a rotor, preventing tilting or rotation of the one or more brake pad assemblies relative to the rotor during retraction.

18. The retraction spring according to claim 1, wherein the retraction spring applies a retraction force greater than a frictional force between the caliper housing and the one or more brake pad assemblies.

19. The brake assembly according to claim 11, wherein the brake assembly further includes a leading end and a trailing end located at opposing ends of the caliper housing, and wherein each retraction spring crosses a midpoint between the leading end and the trailing end.

20. The brake assembly according to claim 19, wherein the midpoint is located substantially along an axis of rotation of a rotor.
